(19) United States
(12) Patent Application Publication
(10) Pub. No.: US 2010/0108967 A1
(43) Pub. Date: May 6, 2010

(54) Jack with Scale Including Protective Cover

(76) Inventor: Kenichi Endo, Saitama (JP)

Correspondence Address: QUARLES & BRADY LLP, 411 E. WISCONSIN AVENUE, SUITE 2040, MILWAUKEE, WI, 53202-4497, US

(21) Appl. No.: 12/529,874

(22) PCT Filed: Mar. 6, 2008
(86) PCT No.: PCT/US08/56022

§ 371 Date: Sep. 3, 2009

(30) Foreign Application Priority Data
Mar. 12, 2007 (JP) 2007-061-429

(51) Int. Cl. B66F 3/25

(52) U.S. Cl. 254/93 R; 137/556

(57) ABSTRACT

A simple, inexpensive jack that can be used in severe working environments and can check an amount of raising and lowering movements of a piston of the jack at any time during working. The jack includes a cylinder, a piston capable of raising and lowering movements within the cylinder and a protective cover for covering at least a part of the outer circumference side surface of the cylinder, the protective cover having an inner circumference larger than the outer circumference of the cylinder and having one end fixed adjacent to the top end of the piston via a saddle and the other end being open, and a scale on the outer side surface of the cylinder. The amount of the raising and lowering movements of the piston is indicated by the relationship between the open end of the protective cover and the scale.

### CROSS-REFERENCE TO RELATED APPLICATION

This application claims the priority benefit of Japanese Patent Application No. 2007-061429 filed Mar. 12, 2007.

### STATEMENT CONCERNING FEDERALLY SPONSORED RESEARCH OR DEVELOPMENT

Not applicable.

### FIELD OF THE INVENTION

The present invention relates to a jack. More particularly, the present invention relates to a jack with a cover for protecting a piston.

### BACKGROUND OF THE INVENTION

FIG. 7 shows a conventional jack or cylinder having a protective structure such as disclosed in Japanese Patent Publication No. 2006-161980. A jack 30 includes a cylinder 31, a piston 32 capable of being raised and lowered within the cylinder 31, and a bellows 35 for protecting the piston 32 from dust and the like. One end of the bellows 35 is fixed to the outer circumference of the cylinder 31 with a fixing band 38b and the other end is fixed to the outer circumference of the piston 32 with a fixing band 38a. The jack 30 further includes a saddle 37 for supporting a load and protecting a screw at the top end of the piston 32.

The bellows 35 is typically made of rubber, cloth, synthetic resin, and the like so that the bellows 35 may stretch in response to the raising and lowering movements of the piston 32. However, when the bellows 35 experiences an external shock by a rigid tool, such as a hammer, undesirable flaws or dents may be created on a cylinder of the piston 32. These flaws may result in a leakage of gas or fluid for driving the jack 30. Such leakage may compromise the safe operation of the jack and reduce its operating life. Moreover, if the jack is located near a welding site, grinder, or another source providing heated debris, then the heated debris may scatter onto the bellows 35. The heated debris may melt and damage the bellows 35 and then adhere to the piston 32. Accordingly, the debris may adhere to the piston 32 and prevent the smooth operation of the jack 30.

It may also be desirable to measure the position of the load or structure during a lift operation. However, the conventional jack shown in FIG. 7 does not include a mechanism or structure for checking and/or reading the position of the piston 32. Thus, a separate mechanism from the jack must be provided for indicating, measuring, and checking the positions of the piston 32.

Hence, there is a need for a simple, inexpensive jack which can be used in severe working environments, particularly in the presence of dust, weld spatter, and sparks caused by the operation of grinders and the like. Moreover, there is a need for an improved way to indicate, measure, and check the position of the piston of the jack.

### SUMMARY OF THE INVENTION

A jack according to the present invention comprises a cylinder, a piston, a protective cover, and a scale. The piston is capable of raising and lowering movements within the cylinder. The protective cover shields at least a part of the outer circumferential side surface of the cylinder and has an inner circumference larger than the outer circumference of the cylinder, an attached end fixed to the piston, and an open end. The scale is formed on the outer circumference side surface of the cylinder. The amount of the raising and lowering movements of the piston is indicated by the open end of the protective cover and the scale. The protective cover may be disposed to cover the whole of the piston protruding from the cylinder (i.e., the piston exposed out of the cylinder due to the raising movement of the piston) when the piston is raised and lowered. The open end of the protective cover may move relative to the scale in response to the raising and lowering movements of the piston, whereby the amount of the raising and lowering movements of the piston can be indicated.

Thus, the mechanical control and the operating life of the jack is not affected due to the working environment scattering dust, weld spatters, sparks from a grinder and the like, because the piston of the jack is protected by the protective cover. Moreover, the amount of raising and lowering movements of the piston can be checked visually by comparing the positional variation of the open end of the protective cover and the scale formed on the outer circumference side surface of the cylinder.

Although the position where one end of the protective cover is fixed to the piston is not limited, the protective cover may be fixed near to the top end of the piston via a saddle. In this case, the whole of the piston protruding (exposed) out of the cylinder is covered with the protective cover so that the piston can be satisfactorily protected from the external environment. However, in a jack having the piston that is not completely accommodated in the jack or a part of the piston being exposed out of the cylinder in the most descended position of the piston in the cylinder, it is not necessary to cover the entire cylinder with the protective body, because the sliding operation is not adversely affected by the exposed portion of the piston.

The protective cover is preferably made of a rigid inelastic material. For example, if the protective cover is made of a rigid inelastic material, such as, iron, stainless steel and the like, then the piston can be satisfactorily protected from dust, weld spatters, external shock, and the like.

The jack may include a cover which partially covers the cylinder on the base side thereof. The outer circumference of the cover may be larger than the outer circumference of the protective cover. According to this jack, the installation of the jack is not limited to the vertical direction.

Moreover, the scale may have graduations in the directions of both raising and lowering the piston, which make the scale easy to read. If the cylinder is provided with the scale in at least two locations, graduations can be read from multiple directions.

The jack according to the present invention may be a cylindrical jack. In this case, the cylindrical jack includes a cylinder, a piston capable of a raising and lowering movements within the cylinder, a cylindrical protective cover having the inner diameter larger than the outer diameter of the cylinder and covering the whole of the piston protruding from the cylinder due to the raising and lowering movements of the piston and a part of the outer circumference side surface of the cylinder, and a scale formed on the outer circumferential side surface of the cylinder. The cylindrical protective cover has an upper end and a lower end. The upper end of the protective cover is fixed adjacent to the top end of the piston via a saddle and the lower end of the protective cover is open. The lower end can be moved relative to the scale in response to the raising and lowering movements of the piston.

The foregoing and other objects and advantages of the invention will appear in the detailed description which follows. In the description, reference is made to the accompanying drawings which illustrate various aspects of the invention.

### BRIEF DESCRIPTION OF THE DRAWINGS

FIG. 1 is a cross sectional view illustrating a jack according to one aspect of the present invention;

FIG. 2A is a side view illustrating the jack having a protective cover and a scale according to the present invention with a piston at its original position;

FIG. 2B is a side view illustrating the jack having a protective cover and a scale according to the present invention with a piston elevated;

FIG. 3 is a diagram illustrating a label for a scale according to the present invention;

FIG. 4 is a top view illustrating the jack with labels attached to plural portions thereof according to the present invention;

FIG. 5A is a cross sectional view illustrating a jack according to another aspect of the present invention;

FIG. 5B is a side view illustrating how to use the jack of FIG. 5a;

FIG. 6A is a side view illustrating an integrated pump jack;

FIG. 6B is a side view illustrating the jack including the protective cover and the scale according to the present invention which is installed in a conventional integrated pump jack;

FIG. 7 is a side view showing an example of a conventional jack.

### DETAILED DESCRIPTION OF THE INVENTION

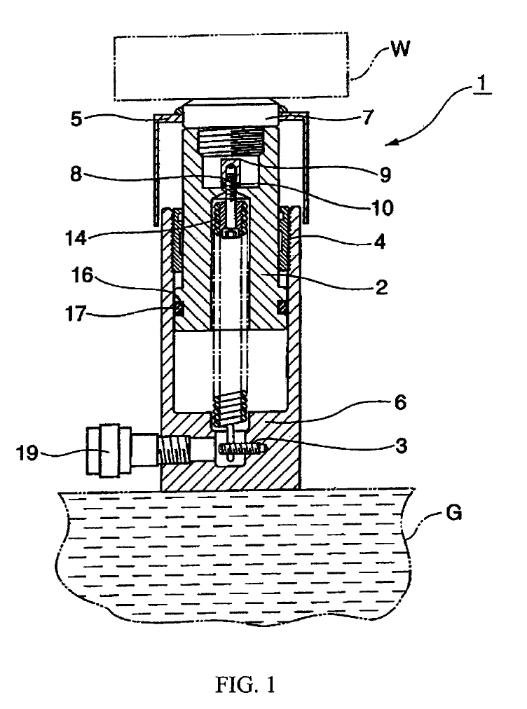

Referring now to FIG. 1, a jack 1 is shown according to one aspect of the present invention. The jack 1 comprises a cylinder 6, a piston 2 capable of raising and lowering movements within the cylinder 6, a saddle 7 disposed near to the top end of the piston 2 for supporting a load, and a protective cover 5 having the upper end fixed to the saddle 7 by welding, screwing, or the like. The protective cover 5, which may also be referred to as a skirt, is fixed to the piston 2 via the saddle 7 and is open at an unattached lower end. Accordingly, although the protective cover 5 moves in response to the raising and lowering movements of the piston 2, the load W is applied to the saddle 7 and the piston 2, such that the protective cover 5 is free from the load W. The protective cover 5 covers the piston 2 to protect the piston 2 from the external environment. Specifically, the protective cover 5 is disposed to completely cover the portion of the piston 2 which protrudes out of the cylinder 6 due to the raising and lowering movements of the piston 2, namely, the exposed upper portion of the piston which is not covered with the cylinder 6, hereinafter referred to as “exposed portion”.

Because the exposed portion of the piston 2 is elevated and descended according to the raising and lowering movements of the piston 2, the protective cover 5 is disposed to completely cover the exposed portion in the most raised (elevated) position of the piston 2. Accordingly, the exposed portion of the piston 2 is always covered with the protective cover 5, in any of the raised and lowered positions of the piston 2 in the cylinder 6.

The protective cover 5 is preferably made of a rigid inelastic material, such as, for example, iron, stainless steel, and the like. The protective cover 5 of the rigid inelastic material can protect the piston 2 satisfactorily from an external shock, scattering dust, melted metal, and the like.

The inner circumference of the protective cover 5 is larger than the outer circumference of the cylinder 6. In other words, a suitable gap is formed between the outer circumference surface of the cylinder 6 and the inner circumference surface of the protective cover 5. Thus, the protective cover 5 can be smoothly raised and lowered by the piston 2 via the saddle 7 without being disturbed by the cylinder 6.

Although the protective cover 5 is fixed adjacent to the top end of the piston 2 via the saddle 7 in accordance with one aspect of the invention, the present invention should not be limited to this configuration. For example, it is not necessary to cover the portion of the piston which does not affect the sliding movement of the piston 2, such as the portion of the piston which is always outside the cylinder 6 and is always exposed regardless of the raised or lowered position of the piston 2. In this case, the protective cover 5 may be fixed to a part of the piston 2 such that the protective cover 5 covers the portions of the piston that may enter the cylinder and would benefit from protection.

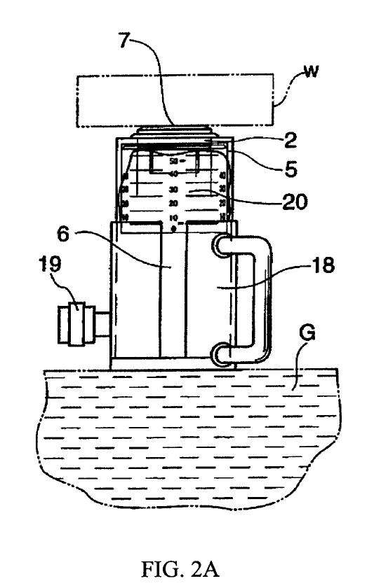

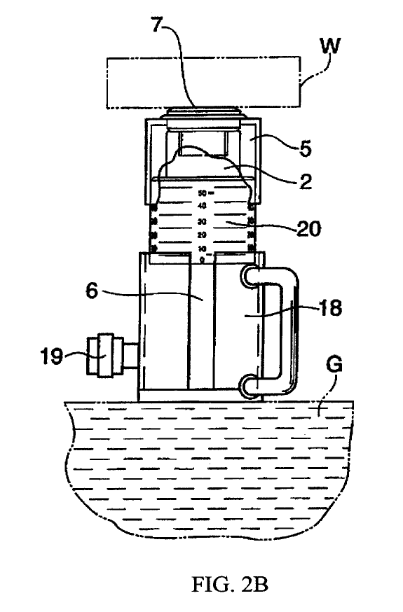

In addition to the protective cover 5, the jack according to the present invention includes a scale 20 which is formed on the cylinder 6 as shown in FIGS. 2A and 2B for indicating, checking, and measuring the position of the piston 2. FIG. 2A shows that the piston 2 of the jack in the most lowered and descended position. FIG. 2B shows that the piston 2 of the jack in a raised and elevated position, specifically, in a position where the piston 2 is raised to 40 mm on the scale. As described above, the protective cover 5 moves in conjunction with the raising and lowering movements of the piston 2. That is, the open end of the protective cover 5, namely, the open end opposite to the upper end fixed to the saddle 7, functions as an indicator of the scale showing the quantitative amount of the raising and lowering movements of the piston 2 numerically. There is a certain limit in the amount of the raising and lowering movements of the piston 2 inherent in the structure of the jack. However, the margin of the raising and lowering stroke of the piston 2 can be confirmed and displayed by the scale 20 and the position of the open end of the protective cover 5.

In order to indicate the amount of the raising and lowering movements of the piston 2 by the open end of the protective cover 5 and the scale 20, it is necessary to dispose the open end of the protective cover 5 such that it is always adjacent to the scale 20 formed on the cylinder 6, regardless of the raising and lowering operation of the piston 2.

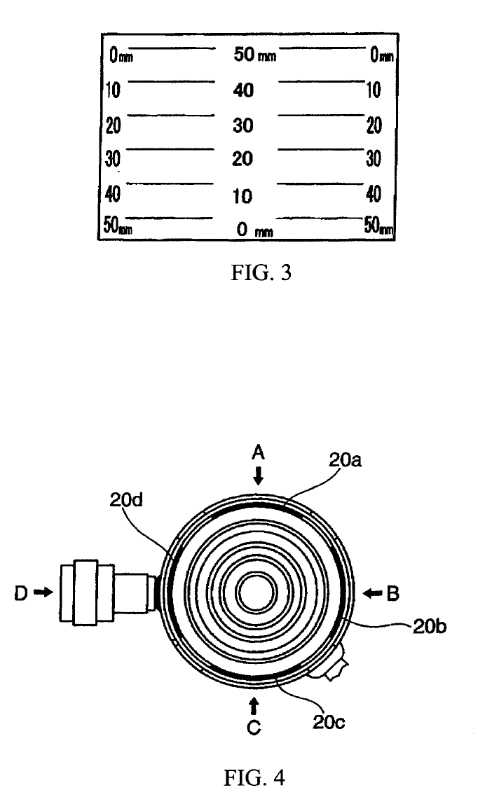

The scale 20 formed on the outer circumference side surface of the cylinder 6 may be engraved directly with a laser. Alternatively, a label on which a scale is printed, such as shown in FIG. 3, may be adhered on the cylinder 6.

The scale 20 may be formed on plural positions of the cylinder 6. FIG. 4 shows the cylinder jack 1 having scales 20a, 20b, 20c, and 20d formed on the four positions A, B, C and D, respectively, as viewed from above. The jack shown in FIG. 4 allows the amount of the raising and lowering movements of the piston 2 to be read from various angles. Moreover, the graduations in both the ascending and descending order may be formed with respect to the raising and lowering directions of the piston 2 as shown in FIG. 3 so as to permit the amount of the raising and lowering movements to be easily read.

The present invention is applicable to various shaped jacks, without being limited to a cylindrical shape. However, a cylindrical jack is general and preferable in the structure, and will be explained in detail hereinafter. The cylindrical jack 1 has a cylindrical protective cover 5. The upper end of the protective cover 5 is connected near to the top end of the piston 2 via the saddle 7 and the lower end thereof is open. Both ends move in response to the raising and lowering movements of the piston 2. The cylindrical protective cover 5 covers and protects the piston 2 protruded from the cylinder 6 and is disposed to cover a part of the cylinder 6. In this case, the outer diameter of the cylinder 6 is slightly smaller than the inner diameter of the protective cover 5 so as to permit the protective cover 5 to move smoothly in response to the raising and lowering movements of the piston 2, with the outer circumference of the cylinder 6 partially kept covered. In other words, the lower end of the protective cover 5 can travel smoothly on the scale 20, which works as an indicator for the amount of the raising and lowering movements of the piston 2.

The jack is operated with a drive medium such as liquid or gas supplied from a coupler 19. The inside of the jack is isolated from the outer atmosphere and hermetically sealed by means of a backup ring 16, a packing 17, a nut 9, and a gasket 10. The piston 2 can be elevated by increasing the internal pressure of the jack with the drive medium supplied from the coupler 19. A stop ring 4 is disposed on the inner side surface of the cylinder 6 in order to prevent the piston 2 from jumping out of the jack and restrict the elevation amount of the piston 2. A return spring 14 is disposed in the cylindrical chamber inside the piston 2 in order to return the piston 2 when the internal pressure of the jack is decreased. The return spring 14 is fixed with the screws 3 and 8, and stretches in response to the raising and lowering movements of the piston 2.

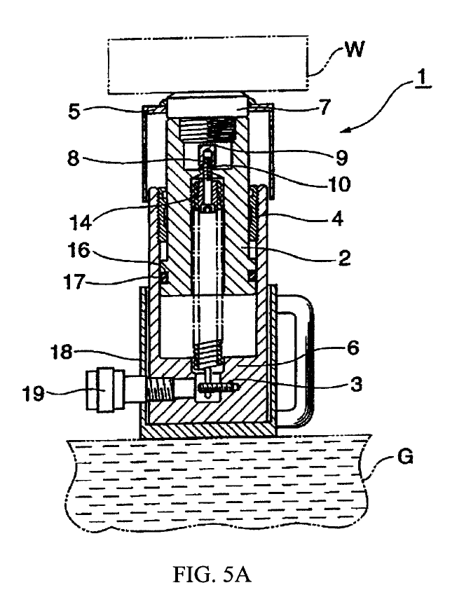

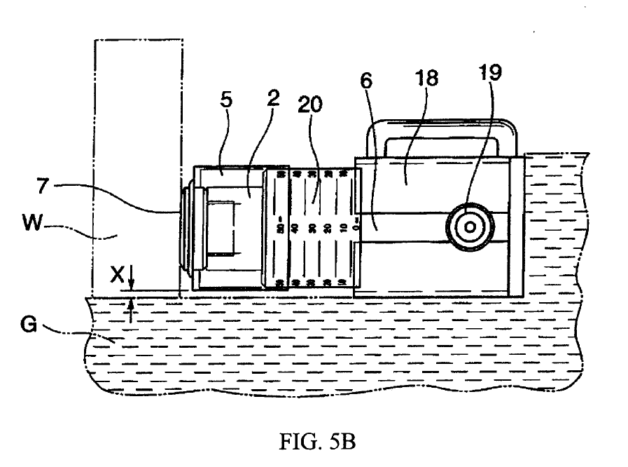

FIGS. 5A and 5B show another aspect of the present invention. As shown in FIGS. 5A and 5B, the jack 1 has a cover 18 which partially covers the base side of the cylinder 6. The outer circumference of the cover 18 is larger in width and diameter than the outer circumference of the protective cover 5. In accordance with this aspect of the invention, the jack 1 can be operated without limiting the installation of the jack to the vertical direction. As shown in FIG. 5B, the jack 1 can be installed horizontally. Because the outer circumference of the cover 18 is larger than that of the protective cover 5, a gap X is defined between the reference surface G and the outer circumference surface of the protective cover 5. Accordingly, the piston 2 can freely move forward and backward while the protective cover 5 does not rub against the reference surface G. Although shown as being installed in the vertical and horizontal directions, the jack can be installed in directions other than the vertical and horizontal.

The various aspects of the present invention have been described above, however, the present invention should not be limited to those various aspects. It would be obvious to a person skilled in the art that various modifications and changes can be made within the scope of the attached claims. For example, the present invention can be used for a jack using any one of air, gas, oil, an electric motor and the like as a drive source. Moreover, the protective cover and the scale of the present invention are applicable to jacks of various shape. For example, in addition to a cylindrical jack, the protective cover and the scale are applicable to jacks in a shape of a triangular prism, quadrangular prism, pentagonal prism, or a combination thereof.

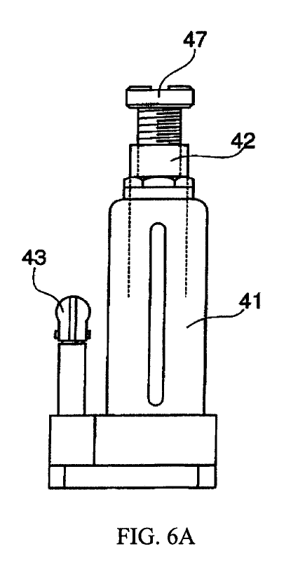

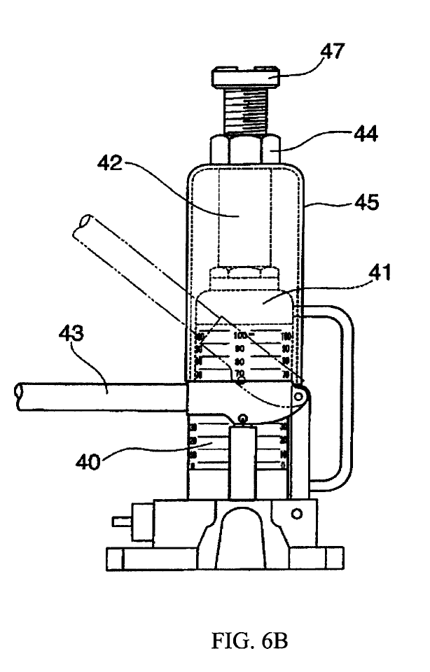

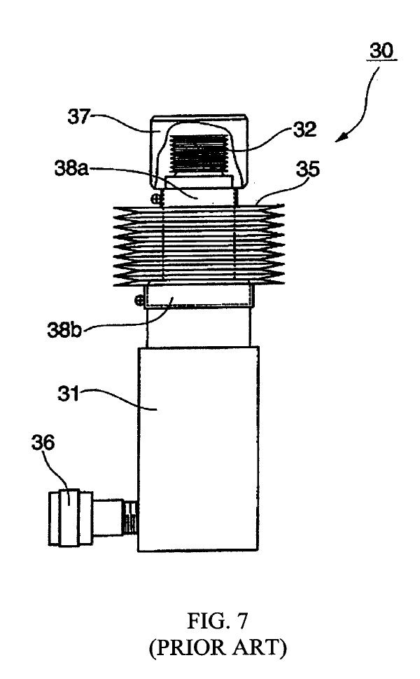

The present invention can be easily applied to a conventional jack, for example, an integrated pump jack as shown in FIG. 6A. The protective cover 45 and the scale 40 according to the present invention can be added to a general jack as shown in FIG. 6B.

Various aspects of the invention has been described in considerable detail. Many modifications and variations to the aspects of this invention described will be apparent to a person of ordinary skill in the art. Therefore, the invention should not be limited to the various aspects described above.

I claim:

1. A jack comprising:
a cylinder;
a piston capable of raising and lowering movements within the cylinder;
a protective cover for covering at least a part of an outer circumferential surface of the cylinder, the protective cover having an inner circumference larger than an outer circumference of the cylinder, an attached end fixed to the piston, and an open end; and
a scale on the outer circumferential surface of the cylinder;
wherein an amount of the raising and lowering movements of the piston is indicated by the open end of the protective cover and the scale.

2. The jack of claim 1, further comprising a saddle fixing the attached end of the protective cover to the piston.

3. The jack of claim 1, wherein the protective cover is provided in such a manner that a whole of the piston protruding from the cylinder is covered by the protective cover when the piston moves upward and downward.

4. The jack of claim 1, wherein the protective cover is made of a rigid inelastic material.

5. The jack of claim 1, wherein the open end of the protective cover is shifted with respect to the scale in response to the raising and lowering movements of the piston so as to indicate an amount of the raising and lowering movements of the piston.

6. The jack of claim 1, further comprising graduations on the scale in at least one of an upward direction and a downward direction of the piston.

7. The jack of claim 6, further comprising graduations on the scale in both the upward direction and the downward direction of the piston.

8. The jack of claim 1, further comprising graduations on the scale including a graduation marking of “0” for a location at which the open end of the protective cover aligns with the scale when the piston is fully lowered.

9. The jack of claim 1, further comprising graduations on the scale including a graduation marking of “0” for a location at which the open end of the protective cover aligns with the scale when the piston is fully raised.

10. The jack of claim 1, further comprising at least two scales formed on at least two positions of the outer circumferential side surface of the cylinder.

11. A jack comprising,
a cylinder;
a piston capable of raising and lowering movements within said cylinder;
a cylindrical protective cover for covering a whole of the piston protruded from said cylinder due to the raising and lowering movements of the piston and a part of an outer circumference side surface of the cylinder, the cylindrical protective cover having an inner diameter larger than an outer diameter of the cylinder; and
a scale on the outer circumferential side surface of the cylinder;
wherein the cylindrical protective cover has an upper end and a lower end, the upper end being fixed adjacent to the piston via a saddle, the lower end being a cylindrical open end, and the lower end shifts close to the scale in response to the raising and lowering movements of the piston.

12. The jack of claim 11, wherein the protective cover is made of a rigid inelastic material.

13. The jack of claim 11, further comprising graduations on the scale in at least one of an upward direction and a downward direction of the piston.

14. The jack of claim 13, further comprising graduations on the scale in both the upward direction and the downward direction of the piston

15. The jack of claim 11, further comprising graduations on the scale including a graduation marking of “0” for a location at which the open end of the protective cover aligns with the scale when the piston is fully lowered.

16. The jack of claim 11, further comprising graduations on the scale including a graduation marking of “0” for a location at which the open end of the protective cover aligns with the scale when the piston is fully raised.

17. The jack of claim 11, further comprising at least two scales formed on at least two positions of the outer circumferential side surface of the cylinder.

18. The jack of claim 11, further comprising a cover for partially covering the cylinder on a base side thereof and wherein an outer circumference of the cover is larger than an outer circumference of the protective cover.
